(19) United States
(12) Patent Application Publication
(10) Pub. No.: US 2005/0151872 A1
(43) Pub. Date: Jul. 14, 2005

(54) Lens module for digital image-capturing device

(76) Inventor: Roger Kuo, Tainan Hsien (TW)

Correspondence Address: GROSSMAN, TUCKER, PERREAULT & PFLEGER, PLLC, 55 South Commercial Street, Manchester, NH, 03101, US

(21) Appl. No.: 11/030,448

(22) Filed: Jan. 6, 2005

(30) Foreign Application Priority Data
Jan. 8, 2004 (TW) 093200305

(51) Int. Cl. H04N 5/225

(52) U.S. Cl. 348/335

(57) ABSTRACT

A lens module for a digital image-capturing device includes a seat including a base wall with an opening formed therethrough; a telescopic pipe disposed in front of the base wall and including a rear pipe part that extends forwardly from the base wall and that is axially aligned with the opening in the base wall, and a front pipe part coaxially and movably coupled to a distal end of the rear pipe part; a lens assembly removably coupled to the front pipe part; and an image sensing device mounted rearwardly of the base wall to receive an image focused by the lens assembly through the opening. Movement between the rear and front pipe parts results in adjustment of a focal length between the lens assembly and the image sensing device.

### CROSS-REFERENCE TO RELATED APPLICATION

This application claims priority of Taiwanese Application No. 93200305, filed on Jan. 8, 2004.

### BACKGROUND OF THE INVENTION

1. Field of the Invention

The present invention relates to a lens module, and more particularly to a lens module for a digital image-capturing device.

2. Description of the Related Art

The digital camera is experiencing increasingly widespread use. The digital camera is also being merged with other technologies to result in multi-functional devices, such as the cell phone/camera combination (camera phone) and digital camera binoculars.

Referring to FIG. 1, a pair of conventional digital camera binoculars 1 includes an upper casing 12, a focus wheel 11 rotatably mounted to the upper casing 12, a pair of lens tubes 112 pivotally mounted to the upper casing 12 on opposite sides of the upper casing 12 and with the focus wheel 11 interposed therebetween, and a lower casing 13 mounted to the upper casing 12. The focus wheel 11 is operated by a user to perform focusing with respect to the lens tubes 112. A lens assembly 14 is mounted to a front end of the lower casing 13, and an image sensor 15 is mounted behind the lens assembly 14 in the lower casing 13. A microprocessor and circuitry (not shown) are also included in the digital camera binoculars 1 which process the electrical charges accumulated in the image sensor 15.

Part of the procedure to assemble the digital camera binoculars 1 involves adjusting the focal length between the lens assembly 14 and the image sensor 15. This is accomplished by first mounting the lens assembly 14 and the image sensor 15 to the lower casing 13, then finely adjusting the distance between the lens assembly 14 and the image sensor 15 using computer equipment until the desired focal length between these elements is obtained. The lens assembly 14 and the image sensor 15 are then glued to the lower casing 13 in this state where the focal length therebetween has been adjusted. However, such a method to adjust the focal length is time-consuming and difficult to perform.

After the digital camera binoculars 1 is completely assembled, final testing is typically performed. If the tests reveal malfunctioning of the lens assembly 14 such that focusing is not possible, or malfunctioning of the image sensor 15 such that it is not possible to clearly capture images, it may be necessary to disassemble the lower casing 13 from the upper casing 12 and remove the lens assembly 14 and the image sensor 15 from the lower casing 13 to determine whether adjustments need to be performed or replacement of these elements is necessary. However, since the lens assembly 14 and the image sensor 15 are glued to the lower casing 13, they may become damaged during this process. If the lens assembly 14 and the image sensor 15 require replacement as a result, overall manufacturing costs are increased, while if the damage goes undetected, a defective final product may result.

### SUMMARY OF THE INVENTION

The object of this invention is to provide a lens module that allows for easy replacement of parts and simple adjustment of a focal length between a lens assembly and an image sensing assembly.

A lens module for a digital image-capturing device includes: a seat including a base wall, and an opening formed through the base wall; a telescopic pipe disposed in front of the base wall and including a rear pipe part that extends forwardly from the base wall and that is axially aligned with the opening in the base wall, and a front pipe part having a rear end segment coaxially and movably coupled to the rear pipe part, the front pipe part further having a front end segment; a lens assembly coupled to the front end segment of the front pipe part; and an image sensing device mounted rearwardly of the base wall of the seat to receive an image focused by the lens assembly through the opening in the base wall. Relative movement between the rear pipe part and the front pipe part results in adjustment of a focal length between the lens assembly and the image sensing device.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of conventional digital camera binoculars;

FIG. 2 is an exploded perspective view of digital camera binoculars to which there is applied a lens module according to a preferred embodiment of the present invention;

FIG. 3 is an exploded perspective view of the lens module of FIG. 2; and

FIG. 4 is a view similar to FIG. 3, but taken from a rear perspective and with only a focus lens and an image sensor disassembled from a seat of the lens module.

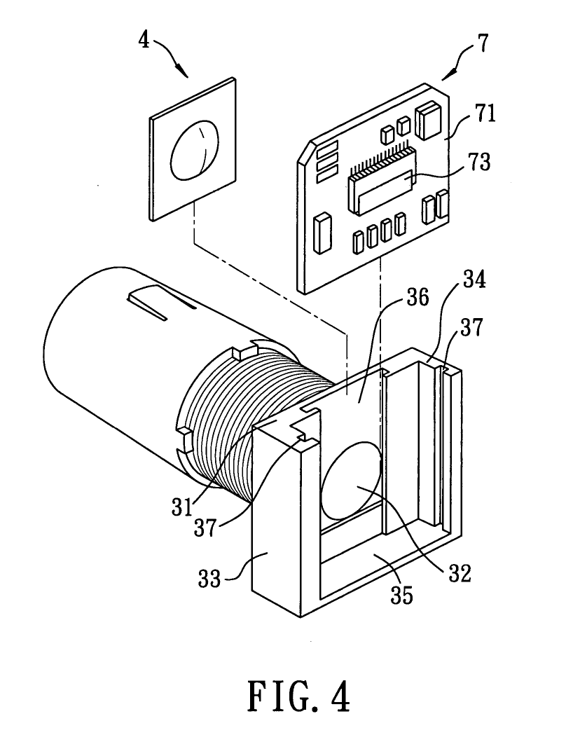

### DETAILED DESCRIPTION OF THE PREFERRED EMBODIMENT

A lens module according to a preferred embodiment of the present invention may be employed in a digital image-capturing device, examples of which include a digital camera and digital camera binoculars. In the description to follow, the lens module of the present invention is described as being employed in a pair of digital camera binoculars. However, it is to be understood that the lens module of the present invention may find a wide range of applications and is not limited to utilization in digital camera binoculars as described below.

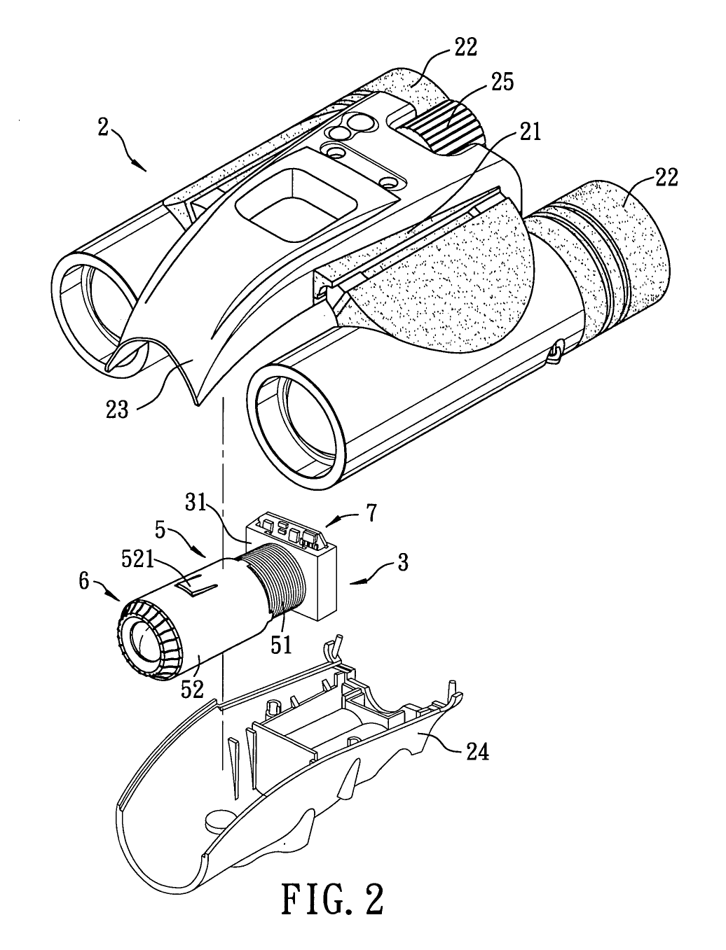

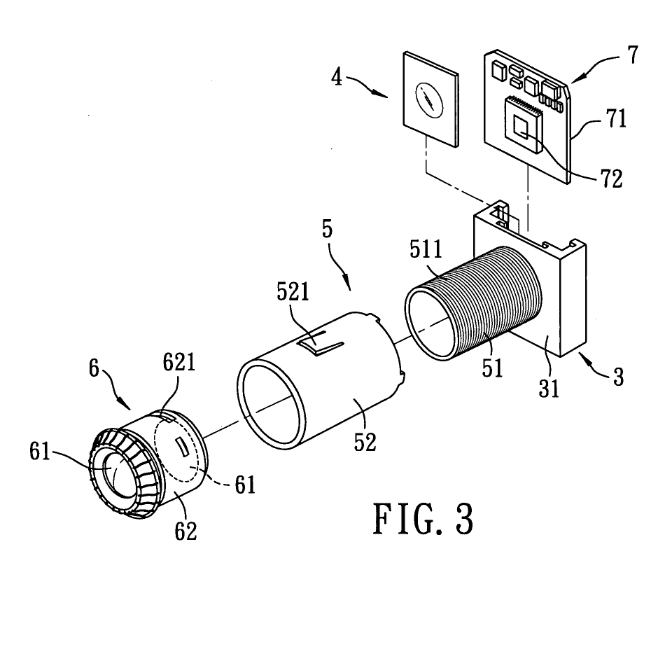

Referring to FIGS. 2 and 3, a pair of digital camera binoculars 2 to which the lens module according to a preferred embodiment of the present invention is employed includes an upper casing 23, a pair of pivoting shoulders 21 mounted to opposite sides of the upper casing 23, a focus wheel 25 rotatably mounted to the upper casing 23, a pair of lens tubes 22 respectively mounted to the pivoting shoulders 21 with the focus wheel 24 interposed therebetween, and a lower casing 24 mounted to the upper casing 23. The lens module is mounted between the upper casing 23 and the lower casing 24.

The lens module includes a seat 3, a telescopic pipe 5, a lens assembly 6, a focus lens 4, and an image sensing device 7. The seat 3 includes a base wall 31, and an opening 32 formed through the base wall 31. The base wall 31 is formed with a lens-retaining slot 36 that intersects the opening 32, and has opposite lateral sides, and an end wall part that extends between the lateral sides. In the preferred embodiment, the end wall part is a bottom side of the base wall 31. A pair of lateral side walls 33, 34 extend rearwardly and respectively from the opposite lateral sides of the base wall 31, and a stop wall 35 extends rearwardly from the end wall part of the base wall 31. Further, aligned retaining grooves 37 are formed respectively in the lateral side walls 33, 34.

The telescopic pipe 5 is disposed in front of the base wall 31. The telescopic pipe 5 includes a rear pipe part 51 that extends forwardly from the base wall 31 and that is axially aligned with the opening 32 in the base wall 31, and a front pipe part 52 having a rear end segment coaxially and movably coupled to the rear pipe part 51. The front pipe part 52 further has a front end segment opposite the rear end segment, and a resilient hook 521 is formed on the front end segment of the front pipe part 52, the purpose of which will be described below. Preferably, the rear pipe part 51 of the telescopic pipe 5 is formed with an external thread 511, and the rear end segment of the front pipe part 52 of the telescopic pipe 5 engages threadedly the external thread 511 of the rear pipe part 51.

The lens assembly 6 includes a lens barrel 62 coupled removably to the front end segment of the front pipe part 52 of the telescopic pipe 5, and at least one objective lens 61 mounted in the lens barrel 62. A radial aperture 621 is formed through the lens barrel 62. The radial aperture 621 of the lens barrel 62 and the resilient hook 521 of the front pipe part 52 form an interlocking assembly, and cooperate to removably mount the lens assembly 6 to the telescopic pipe 5.

The focus lens 4 is retained removably in the lens-retaining slot 36. The focus lens 4 is aligned with the opening 32 when positioned in the lens-retaining slot 36.

The image sensing device 7 is mounted rearwardly of the base wall 31 of the seat 3 to receive an image focused by the lens assembly 6 through the opening 32 in the base wall 31. The focus lens 4 is interposed between the image sensing device 7 and the base wall 31 of the seat 3. The image sensing device 7 includes a circuit board 71, an image sensor 72 mounted on the circuit board 71, and an output port 73 mounted on the circuit board 71. The retaining grooves 37 of the lateral side walls 33, 34 of the seat 3 removably retain the circuit board 71. As a result, the image sensing device 7 is retained between the lateral side walls 33, 34 in such a manner that the image sensor 72 is aligned with the opening 32 in the base wall 31. The image sensor 72 may be a charge coupled device sensor or a complementary metal oxide semiconductor sensor. Since the image sensing device 7 operates in a conventional manner, a detailed description thereof will not be provided.

The lens module of the present invention structured as described above has the following advantages:

1. A focal length between the lens assembly 6 and the image sensing device 7 may be easily adjusted by simply rotating the front pipe part 52, thereby resulting in movement of the same relative to the rear pipe part 51. (A weak adhesive may be applied between the front pipe part 52 and the rear pipe part 51 to firmly secure the positioning of the front pipe part 52 after focal length adjustment is performed.)

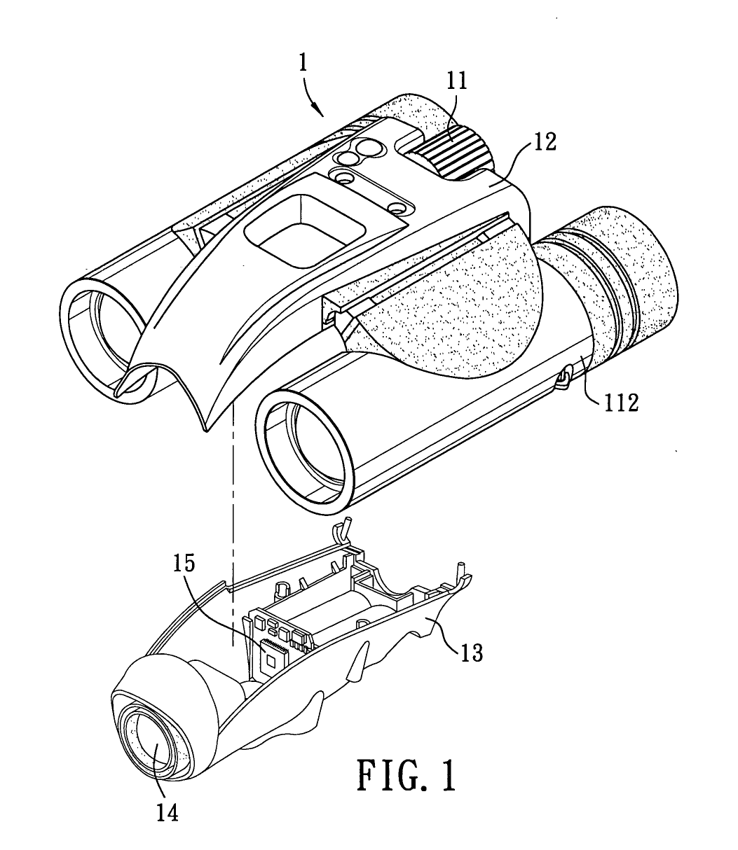

2. If, during testing, it is discovered that the lens assembly 6 is defective, it is necessary only to release the hook 521 and replace the lens assembly 6. Therefore, there is no possibility of damage to the lens assembly 6. This is in contrast to the conventional configuration in which the lens assembly 14 is glued to the lower casing 13 (see FIG. 1).

3. The focus lens 4 and the image sensing device 7 can also be easily and safely replaced by simply sliding these elements from the lens-retaining slot 36 and the retaining grooves 37, respectively.

4. Assembly of the lens module during manufacture is made easy by the removable interconnections between the elements of the lens module as described above.

5. Adjusting and testing of the lens module may be performed prior to mounting the lens module to the system to which it is applied. Therefore, testing is made more convenient.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A lens module for a digital image-capturing device, comprising:
a seat including a base wall, and an opening formed through said base wall;
a telescopic pipe disposed in front of said base wall and including a rear pipe part that extends forwardly from said base wall and that is axially aligned with said opening in said base wall, and a front pipe part having a rear end segment coaxially and movably coupled to said rear pipe part, said front pipe part further having a front end segment;
a lens assembly coupled to said front end segment of said front pipe part; and
an image sensing device mounted rearwardly of said base wall of said seat to receive an image focused by said lens assembly through said opening in said base wall;
wherein relative movement between said rear pipe part and said front pipe part results in adjustment of a focal length between said lens assembly and said image sensing device.

2. The lens module of claim 1, further comprising a focus lens mounted to said seat and disposed in front of said image sensing device, said focus lens being aligned with said opening in said base wall.

3. The lens module of claim 2, wherein said base wall is formed with a lens-retaining slot that intersects said opening, said focus lens being retained removably in said lens-retaining slot.

4. The lens module of claim 1, wherein said base wall has opposite lateral sides, and an end wall part that extends between said lateral sides,
said seat further including a pair of lateral side walls that extend rearwardly and respectively from said opposite lateral sides of said base wall, a stop wall that extends rearwardly from said end wall part of said base wall, and an aligned pair of retaining grooves formed respectively in said lateral side walls to retain removably said image sensing device between said lateral side walls.

5. The lens module of claim 4, wherein said image sensing device includes a circuit board, an image sensor mounted on said circuit board, and an output port mounted on said circuit board,
said circuit board having opposite edges inserted removably and respectively into said retaining grooves in said lateral sidewalls of said seat, thereby retaining said image sensing device between said lateral side walls such that said image sensor is aligned with said opening in said base wall.

6. The lens module of claim 5, wherein said image sensor is one of a charge coupled device sensor and a complementary metal oxide semiconductor sensor.

7. The lens module of claim 1, wherein said rear pipe part of said telescopic pipe is formed with an external thread, and said rear end segment of said front pipe part of said telescopic pipe engages threadedly said external thread of said rear pipe part.

8. The lens module of claim 1, wherein said lens assembly includes a lens barrel coupled removably to said front end segment of said front pipe part of said telescopic pipe, and at least one objective lens mounted in said lens barrel.

9. The lens module of claim 8, further comprising an interlocking assembly for coupling removably said lens barrel to said front end segment of said front pipe part of said telescopic pipe.

10. The lens module of claim 9, wherein said interlocking assembly includes a radial aperture formed through said lens barrel, and a resilient hook formed on said front end segment of said front pipe part to engage removably said lens barrel at said radial aperture.
